(19) United States
(12) Patent Application Publication
(10) Pub. No.: US 2006/0224657 A1
(43) Pub. Date: Oct. 5, 2006

(54) Method, system and apparatus for quotient digit generation

(75) Inventors: Simon Rubanovich, Haifa (IL); Amit Gradstein, Binyamina (IL); Habeeb Farah, Nazareth (IL)

Correspondence Address: PEARL COHEN ZEDEK LATZER, LLP, 1500 BROADWAY, 12TH FLOOR, NEW YORK, NY, 10036, US

(73) Assignee: Intel Corporation

(21) Appl. No.: 11/092,758

(22) Filed: Mar. 30, 2005

(51) Int. Cl. G06F 7/52

(52) U.S. Cl. 708/650

(57) ABSTRACT

Embodiments of the present invention provide a method, apparatus and system to generate a quotient digit corresponding to a quotient of a cycle of a division operation by applying a predetermined criterion to a plurality of expected partial remainder values related to a plurality of possible quotient digits Other embodiments are described and claimed.

### BACKGROUND OF THE INVENTION

A divider may be used to calculate a Quotient, denoted Q, corresponding to division of a number, denoted P (also referred to as a “dividend”), by a divider, denoted D.

A conventional divider may implement a division algorithm, e.g., a Sweeney, Robertson and Tocher (SRT) division algorithm, which may include a series of division cycles, wherein a given cycle may yield a quotient digit.

The divider may include a Quotient-digit Selection Logic (QSL) for generating the quotient digit according to the value of a partial remainder of a previous division cycle, for example, based on a predetermined PD-Plot.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a computing platform including a divider in accordance with some exemplary embodiments of the present invention;

FIG. 2 is a schematic illustration of a quotient digit selector in accordance with some exemplary embodiments of the invention;

FIG. 3 is a schematic illustration of a partial remainder generator, a sign generator, and a detector in accordance with some exemplary embodiments of the invention;

FIG. 4 is a schematic illustration of a quotient digit generator in accordance with some exemplary embodiments of the invention; and

FIG. 5 is a schematic block diagram illustration of a method of generating a quotient digit in accordance with some exemplary embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices In addition, the term “plurality” may be used throughout the specification to describe two or more components, devices, elements, parameters and the like.

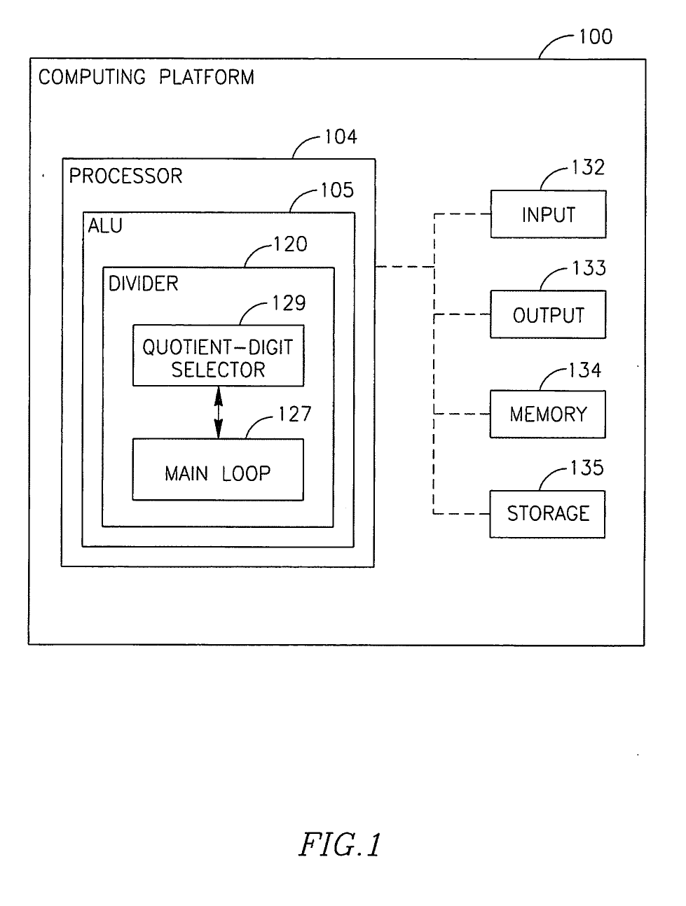

Reference is made to FIG. 1, which schematically illustrates a computing platform 100 in accordance with some exemplary embodiments of the present invention.

According to some exemplary embodiments, platform 100 may include a processor 104. Processor 104 may include, for example, a Central Processing Unit (CPLU), a Digital Signal Processor (DSP), a microprocessor, a host processor, a plurality of processors, a controller, a chip, a microchip, or any other suitable multi-purpose or specific processor or controller.

According to some exemplary embodiments of the invention, processor 104 may include at least one Arithmetic Logic Unit (ALU) 105. ALU 105 may include at least one divider 120 able to determine a Quotient, denoted Q corresponding to a division of a dividend, denoted P, by a divider, denoted D, as described below.

According to some exemplary embodiments of the invention, platform 100 may also include an input unit 132, an output unit 133, a memory unit 134, and/or a storage unit 135. Platform 100 may additionally include other suitable hardware components and/or software components. In some embodiments, platform 100 may include or may be, for example, a computing platform, e.g., a personal computer, a desktop computer, a mobile computer, a laptop computer, a notebook computer, a terminal, a workstation, a server computer, a Personal Digital Assistant (PDA) device, a tablet computer, a network device, a micro-controller, a cellular phone, a camera, or any other suitable computing and/or communication device.

Input unit 132 may include, for example, a keyboard, a mouse, a touch-pad, or other suitable pointing device or input device Output unit 133 may include, for example, a Cathode Ray Tube (CRT) monitor, a Liquid Crystal Display (LCD) monitor, or other suitable monitor or display unit

Storage unit 135 may include, for example, a hard disk drive, a floppy disk drive, a Compact Disk (CD) drive, a CD-Recordable (CD-R) drive, or other suitable removable and/or fixed storage unit

Memory unit 134 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units

According to some exemplary embodiments of the invention, divider 120 may determine the quotient Q using a division algorithm, e.g., a Sweeney, Robertson and Tocher (SRT) division algorithm as is known in the art, for performing x division cycles. A quotient Qₘ₊₁ of a division cycle m+1, m=0 . . . x, may be determined, for example, using the following recursive equations:
R₀=P, Q₀=0 (1)
Rₘ₊₁=rRₘ−qₘ₊₁D (2)
Qₘ₊₁=rQₘ+qₘ₊₁ (3)
wherein Rₘ denotes a partial remainder value corresponding to a previous cycle m, qₘ₊₁ denotes a quotient digit corresponding to cycle M+1, Rₘ₊₁ denotes a partial remainder value corresponding to cycle M+1, Qₘ denotes a quotient corresponding to cycle m, and r denotes a radix of divider 120. The radix r may be determined, for example, by the following equation:
r=2^{p} (4)
wherein p denotes a value related to the number of bits of the quotient digit qₘ₊₁.

According to some exemplary embodiments of the invention, divider 120 may include a quotient digit selector 129 to generate quotient digit qₘ₊₁ by applying a predetermined criterion to a plurality of expected partial remainder values related to a plurality of possible quotient digits, e.g., as described in detail below.

According to some exemplary embodiments of the invention, divider 120 may also include a main loop module 127 to determine the quotient Qₘ₊₁ and/or the partial remainder Rₘ₊₁, e.g., in accordance with Equations 1, 2, and/or 3. Main loop module 127 may include any suitable configuration, for example, a configuration including one or more adders, multiplexers, Carry-Save-Adders (CSAs), latches, flip flop units, and/or any other element, eg., as is known in the art..

According to some exemplary embodiments of the invention, divider 120 may include a high-radix divider, e.g., having a radix of at least four. Accordingly, quotient digit selector 129 may generate two or more bits representing quotient digit qₘ₊₁, as described below.

Although the scope of the present invention is not limited in this respect, as part of the description of some embodiments of the present invention, reference may be made to a high radix divider, e.g., a divider having a radix r≧4. However, it would be obvious to those with ordinary skills in the art of that other embodiments of the invention may include a low-radix divider, e.g., a divider having a radix r=2.

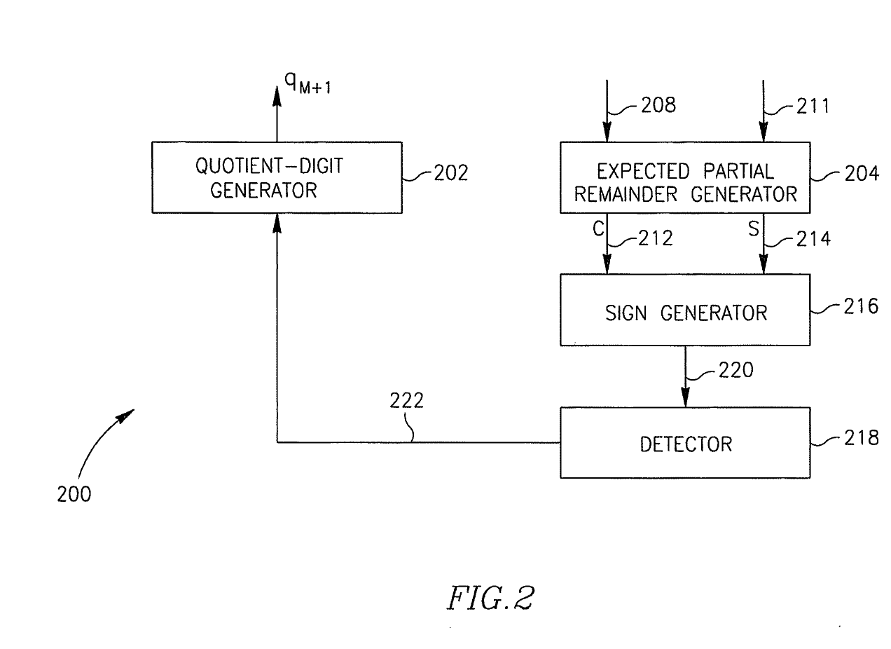

Reference is made to FIG. 2, which schematically illustrates a quotient digit selector 200 in accordance with some exemplary embodiments of the invention.

Although the invention is not limited in this respect, quotient digit selector 200 may perform the functionality of quotient digit selector 129 (FIG. 1). Accordingly, quotient digit selector 200 may be associated, for example, with main loop module 127 (FIG. 1).

According to exemplary embodiments of the invention, quotient digit selector 200 may generate quotient digit qₘ₊₁ by applying a predetermined criterion to a plurality of expected partial remainder values related to a plurality of possible quotient digits, e.g., as described in detail below.

According to some exemplary embodiments of the invention, the plurality of possible quotient digits may correspond to a plurality of predetermined integer values, i=l+1, l, . . . , h, e.g., wherein (−r)≦l and h≦r are predetermined boundary values. The boundary values l and/or h may be predetermined, for example, according to a convergence criterion and/or any other desired criterion, e.g., a desired efficiency level and/or a desired accuracy level of the division operation, as described below.

According to some exemplary embodiments of the invention, the quotient digit qₘ₊₁ may be generated such that an absolute value of partial remainder Rₘ₊₁ corresponding to quotient digit qₘ₊₁ is relatively reduced, e.g., minimized. This may be achieved, for example, by detecting a change in a mathematical property, e.g., a sign, of expected partial remainder values corresponding to two consecutive separator values related to the possible partial remainder values; and generating the quotient digit based on the detected change in property, as described below.

According to exemplary embodiments of the invention, the plurality of expected partial remainder values of the cycle m+1 may include a plurality of values, denoted R ⁱₘ₊₁, corresponding to a plurality of separator values cᵢ. Separator values cᵢ may be related to the plurality of integer values i, respectively. For example, the plurality of separator values may be shifted by a predetermined shift value in relation to the plurality of possible quotient digits, e.g., such that there is one of integer values i between each pair of consecutive separators, cᵢ and cᵢ₊₁. The separator values may be determined, for example, based on the convergence criterion, e.g., as described below.

According to exemplary embodiments of the invention, a change between the signs of two expected partial remainder values corresponding to two consecutive integer values, j and j+1, may indicate the partial remainder Rₘ₊₁ may be relatively reduced, e.g., minimized, by generating a quotient digit qₘ₊₁ corresponding to one of the values j and j+1. The plurality of separator values may be implemented, for example, to determine one of the two consecutive values j and j+1 for which the partial remainder value Rₘ₊₁ may be relatively reduced, e.g., minimized. For example, a change of sign between two expected partial remainder values corresponding to two consecutive separators, cⱼ and cⱼ₊₁, may indicate that the partial remainder value Rₘ₊₁ may be reduced, e.g., minimized, by generating the quotient digit qₘ₊₁ corresponding to the integer value 1, which may be between separators cⱼ and cⱼ₊₁.

According to some exemplary embodiments of the invention, quotient digit selector 200 may include a partial-remainder generator 204 to generate the plurality of expected partial remainder values corresponding to division cycle m+1, for example, based on data signals 208 and/or 211. Data signals 208 and/or 211 may be received, for example, from main loop module 127 (FIG. 1) and/or any other internal or external module, e.g., a pre-processing module (not shown). For example, data 208 may include data corresponding to the product rRₘ of cycle m, and/or data 211 may include data corresponding to divider D, as described below. Generator 204 may generate, for example, a plurality of signal pairs, e.g., including a save (S) signal 214 and carry (C) signal 212, corresponding to the plurality of expected partial remainder values, respectively. For example, generator 204 may generate 16 pairs of signals 212 and 214 representing sixteen expected partial remainder values corresponding to sixteen possible quotient digits, e.g., if selector 200 generates quotient digit qₘ₊₁, corresponding to a division operation of radix eight or more, e.g., sixteen.

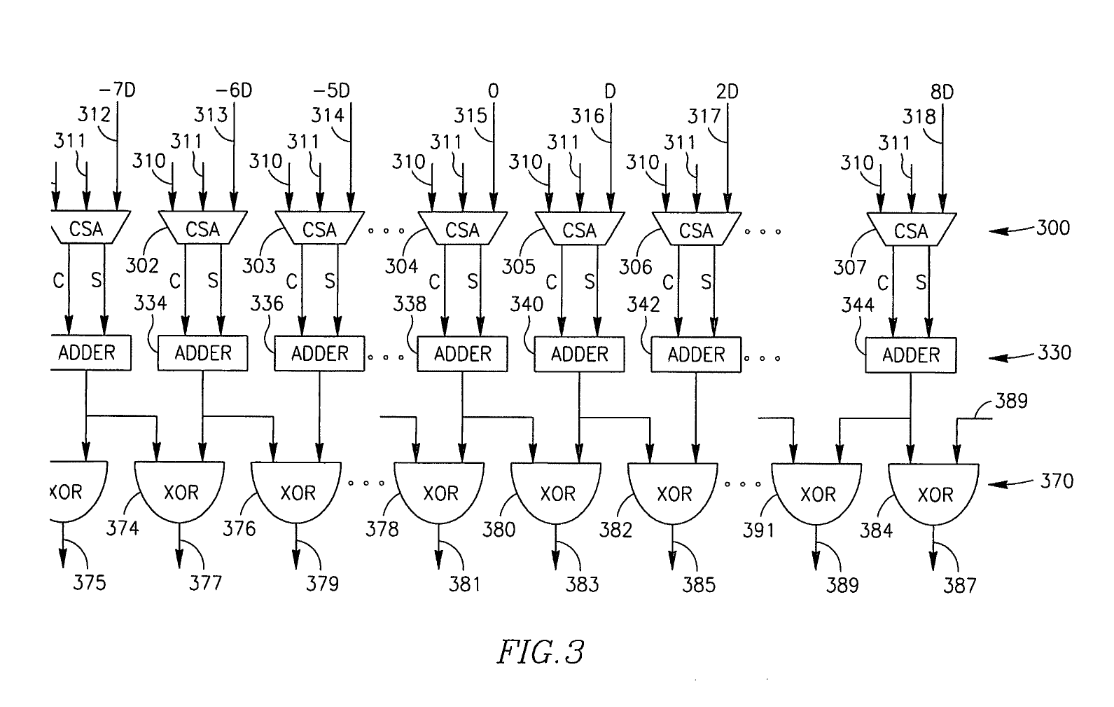

Generator 204 may generate signals 212 and/or 214 corresponding to the values Rⁱₘ₊₁, for example, using the following equation:
Rⁱₘ₊₁=rRⁱₘ−cᵢD (5)
wherein Rⁱₘ denotes the expected partial remainder value of the cycle m corresponding to integer value i. Generator 214 may include any suitable configuration, e.g., as described below with reference to FIG. 3.

According to some exemplary embodiments of the invention, data 208 and/or data 211 may include truncated data in a redundant form. For example, data 208 may correspond to a predetermined truncation number, n, of most-significant bits of the product rRm in a redundant form. Data 211 may include, for example, n most-significant bits of one or more values corresponding to dividend D, as described below Accordingly, signals 214 and 212 may correspond to truncated expected partial remainder values in a redundant form. The truncation number n may be determined, for example, based on the convergence criterion and/or any other criterion, e.g., a desired efficiency and/or accuracy level of the division operation, as described below.

According to some exemplary embodiments of the invention, selector 200 may also include a sign generator 216 for generating a plurality of sign signals 220 corresponding to the plurality of expected partial remainder values, respectively. Generator 216 may include any suitable configuration, e.g., as described below with reference to FIG. 3. For example, generator 216 may include a plurality of adders, e.g., as are known in the art. One or more of the adders may receive carry signal 212 and save signal 214 of one or more of the plurality of expected partial remainder values, respectively, and generate one or more respective sign signals 220 corresponding to the signs of one or more expected partial remainder values, respectively. For example, sign generator 216 may include sixteen adders to generate 16 sign signals 220 of sixteen pairs of signals 214 and 216, e.g., if selector 200 generates quotient digit qₘ₊₁ corresponding to a division operation of radix eight or more.

According to some exemplary embodiments of the invention, selector 200 may also include a detector 218 to detect a change between the signs represented by signals 220. For example, detector 218 may compare the value of one or more pairs of sign signals 220 corresponding to consecutive separator values. Detector may generate one or more indication signals 222 having a value indicative of a change of sign between two consecutive signals 220. Detector 218 may include any suitable detection configuration, e.g., as described below with reference to FIG. 3.

According to some exemplary embodiments of the invention, selector 200 may also include a quotient digit generator 202 to generate quotient digit qₘ₊₁, e.g., based on one or more of indication signals 222. For example, indication signals 222 may indicate a change between two signs, denoted sⱼ and sⱼ₊₁, of expected partial remainder values Rⁱₘ₊₁ and R^{j+1}ₘ₊₁ corresponding to two separator values cⱼ and cⱼ₊₁, respectively Accordingly, quotient bit generator 202 may generate quotient digit qₘ₊₁ e.g., according to the following conditions:
qₘ₊₁=j if j:[l+1 . . . h]
qₘ₊₁=l if j=l−1 (6)
qₘ₊₁=h if j=h−1

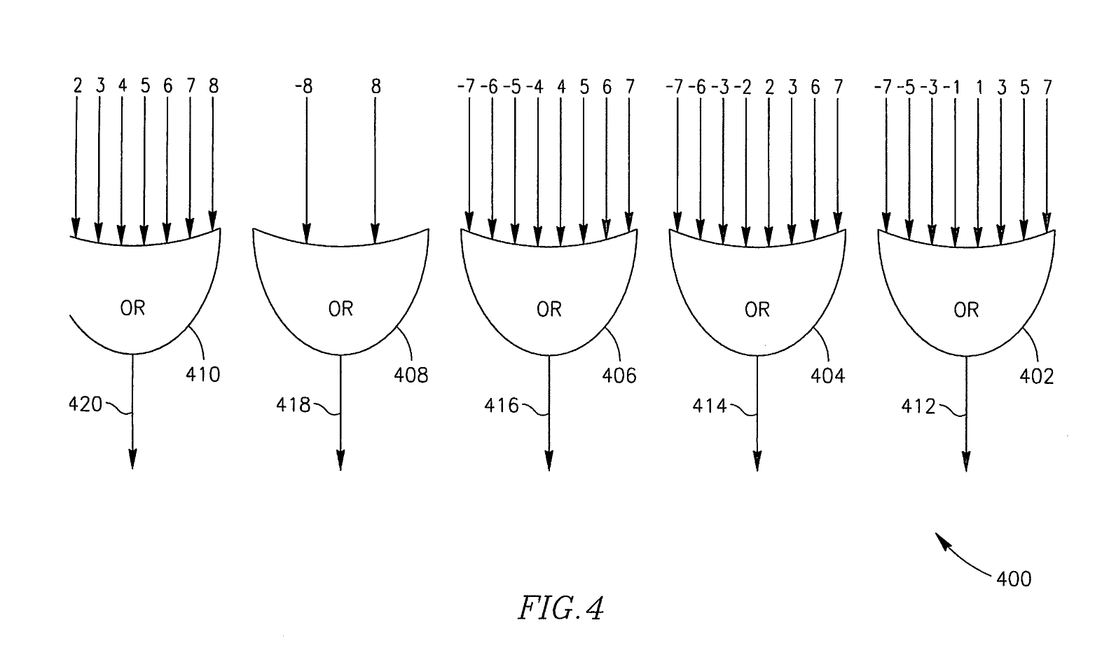

The generated quotient digit qₘ₊₁ may be provided, for example, to main loop 127 (FIG. 1). Generator 202 may include any suitable quotient bit generator configuration, e.g., as described below with reference to FIG. 4.

Reference is made to FIG. 3, which schematically illustrates a partial remainder generator 300, a sign generator 330, and a detector 370 in accordance with some exemplary embodiments of the invention. Although the invention is not limited in this respect, partial remainder generator 300 may perform the functionality of partial remainder generator 204 (FIG. 2), sign generator 330 may perform the functionality of sign generator 216 (FIG. 2), and/or detector 370 may perform the functionality of detector 218 (FIG. 2).

Although the scope of the present invention is not limited in this respect, according to some exemplary embodiments of the invention, partial remainder generator 300, sign generator 330, and/or detector 370 may be implemented as part of a quotient digit selector, e.g., selector 129, for generating a quotient digit qₘ₊₁ corresponding to one of seventeen possible quotient digits. Accordingly partial remainder generator 300, sign generator 330 and/or detector 370 may be implemented, for example, as part of a quotient selector for performing a division operation of a radix of eight or more. However, it will be appreciated by those skilled in the art, that in other embodiments of the invention partial remainder generator 300, sign generator 330, and/or detector 370 may be modified to enable generating a quotient digit qₘ₊₁ corresponding to one of any other desired number of possible quotient digits.

According to the exemplary embodiments of FIG. 3, partial remainder generator 300 may generate a plurality of save and carry signals representing sixteen expected partial remainder values related to sixteen possible quotient digits. Sign generator may generate sixteen sign signals representing the sign of the sixteen expected partial remainder values, respectively. Detector 370 may be able to detect a change between two consecutive signs, and generate one or more, e.g., seventeen, indication signals indicative of the whether a change of sign was detected.

According to some exemplary embodiments of the invention, generator 300 may include a plurality of 3:2 CSAs to receive a plurality of signals corresponding to a plurality of products of the divider D and the integer values i, respectively The plurality of CSAs may also receive a pair of input signals 310 and 311 corresponding to the difference rRM−D/2. For example, signal 310 may have a value corresponding to the carry value of the difference rRm−D/2, and signal 311 may have a value corresponding to the save value of the difference rRm−D/2. Signals 310 and/or 311 may be generated using any suitable method. For example, the value D/2 may be determined by performing a “right shift” to the value of D, which may be received from main loop module 127 (FIG. 1). The difference rRm−D/2 may be determined using a CSA receiving, e.g., from module 127 (FIG. 1), signals representing the values D/2 and/or

According to the exemplary embodiments of FIG. 3, generator 300 may include sixteen CSAs, e.g., including CSAs 301, 302, 303, 304, 305, 306, and 307. CSA 301 may receive signals 310 and 311, and a signal 312 having a value corresponding to the product −7D, and produce a pair of carry and save signals corresponding to the expected partial remainder rRm−7.5D; CSA 302 may receive signals 310 and 311, and a signal 313 having a value corresponding to the product −6D, and produce a pair of carry and save signals corresponding to the expected partial remainder rRm−6.5D; CSA 303 may receive signals 310 and 311, and a signal 314 having a value corresponding to the product 2D, and produce a pair of carry and save signals corresponding to the expected partial remainder rRm+5.5D; CSA 304 may receive signals 310 and 311, and a signal 315 having a zero value, and produce a pair of carry and save signals corresponding to the expected partial remainder rRm−0.5D; CSA 305 may receive signals 310 and 311, and a signal 316 having a value corresponding to D, and produce a pair of carry and save signals corresponding to the expected partial remainder rRm+0.5D; CSA 306 may receive signals 310 and 311, and a signal 317 having a value corresponding to the product 2D, and produce a pair of carry and save signals corresponding to the expected partial remainder rRm+1.5D; and CSA 307 may receive signals 310 and 311, and a signal 318 having a value corresponding to the product 8D, and produce a pair of carry and save signals corresponding to the expected partial remainder rRm+7.5D. Generator 300 may additionally include other CSAs, e.g., nine additional CSAs (not shown), for analogously generating nine respective pairs of carry and save signals corresponding to the expected partial remainders rRm−4.5D, rRm−3.5D, rRm−2.5D, rRm+1.5D, rRm+2.5D, rRm+3.5D, rRm+4.5D, rRm5.5D, and rRm+6.5D. The signals corresponding to the products −7D, −6D, −5D, −4D, −3D, −2D, −D, D, 2D, 3D, 4D, 5D, 6D, 7D and/or 8D may be generated using any suitable configuration. For example, the signals representing the products 7D, 5D, 3D and/or. D may be generated by a pre-processing module, e.g., as known in the art. The signals representing the products −7D, −6D, −5D, −4D, −3D, −2D, −D, 2D, 4D, 6D, and/or 8D may be generated by performing one or more operations on the signals representing the products 7D, 5D, 3D and/or D, e.g., using one or more CSAs.

According to some exemplary embodiments of the invention, generator 330 may include a plurality of adders to receive the plurality of carry-save signal pairs representing the plurality of expected partial remainders; and generate a plurality of sign signals corresponding to the signs of the plurality of expected partial remainders, respectively. For example, a sign signal corresponding to an expected partial remainder value may have a zero value, e.g., if the expected partial remainder is positive; or a value of one, e.g., if the expected partial remainder is negative.

According to the exemplary embodiments of FIG. 3, generator 330 may include sixteen adders, e.g., including adders 332, 334, 336, 338, 340, 342, and 344. Adder 332 may receive the carry and save signals generated by CSA 301, and produce a sign signal having a value corresponding to the sign of rRm−7.5D; adder 334 may receive the carry and save signals generated by CSA 302, and produce a sign signal having a value corresponding to the sign of rRm−6.5D; adder 336 may receive the carry and save signals generated by CSA 303, and produce a sign signal having a value corresponding to the sign of rRm−5.5D; adder 338 may receive the carry and save signals generated by CSA 304, and produce a sign signal having a value corresponding to the sign of rRm−0.5D; adder 340 may receive the carry and save signals generated by CSA 305, and produce a sign signal having a value corresponding to the sign of rRm+0.5D; adder 342 may receive the carry and save signals generated by CSA 306, and produce a sign signal having a value corresponding to the sign of rRm+1.5D; and adder 344 may receive the carry and save signals generated by CSA 307, and produce a sign signal having a value corresponding to the sign of rRm+7.5D. Generator 330 may additionally include other adders, e.g., nine additional adders (not shown), to analogously generate nine respective sign signals corresponding to the sign of rRm−4.5D, rRm−3.5D, rRm−2.5D, rRm−0.5D, rRm+2.5D, rRm+3.5D, rRm+4.5D, rRm+5.5D, and rRm+6.5D.

According to some exemplary embodiments of the invention, detector 370 may include a plurality of exclusive-or (XOR) gates to receive the plurality of sign signals representing the signs of the plurality of expected partial remainders; and generate a plurality of indication signals having values indicative of a change between the signs of two consecutive expected partial remainder values.

According to the exemplary embodiments of FIG. 3, detector 370 may include seventeen XOR gates, e.g., including XOR gates 372, 374, 376, 378, 380, 382, 391 and 384. XOR gate 372 may receive the sign signal generated by adder 332 and a signal 373 having a value corresponding to the sign of the value (−D); and produce an indication signal 375 having a value indicating whether the expected partial remainder rRm−7.5D has the same sign as the value (−D). For example, a zero value of signal 375 may indicate the expected partial remainder rRm−7.5D has the same sign as the value (−D), and a value one of signal 375 may indicate the expected partial remainder rRm−7.5D has a sign different then the sign of the value (−D). Signal 373, may be received, for example, from the pre-processing module (not shown), from main module 127 (FIG. 1) or from any other suitable module. XOR gate 374 may receive the sign signals generated by adders 332 and 334, and produce an indication signal 377 having a value indicating whether the sign of the expected partial remainder rRm−6.5D is different than the sign of expected partial remainder rRm−7.5D. For example, a zero value of signal 377 may indicate the expected partial remainders rRm−6.5D and rRm7.5D have the same sign, and a value one of signal 377 may indicate the expected partial remainders rRm−6.5D and rRm−7.5D have different signs. XOR gate 376 may receive the sign signals generated by adders 336 and 334, and produce an indication signal 379 having a value indicating whether the sign of the expected partial remainder −rRm−5.5D is different than the sign of expected partial remainder rRm−6.5D. XOR gate 378 may receive the sign signals generated by adder 338 and a previous adder, and produce an indication signal 381 having a value indicating whether the sign of the expected partial remainder rRm−0.5D is different than the sign of expected partial remainder rRm−1.5D. XOR gate 380 may receive the sign signals generated by adders 338 and 340, and produce an indication signal 383 having a value indicating whether the sign of the expected partial remainder rRm+1.5D is different than the sign of expected partial remainder rRm−0.5D. XOR gate 382 may receive the sign signals generated by adders 340 and 342, and produce an indication signal 385 having a value indicating whether the sign of the expected partial remainder rRm+0.5D is different than the sign of expected partial remainder rRm+0.5D. XOR gate 391 may receive the sign signals generated by adder 344 and a previous adder, and produce an indication signal 389 having a value indicating whether the sign of the expected partial remainder rRm+7.5D is different than the sign of expected partial remainder rRm+6.5D. XOR gate 384 may receive the sign signal generated by adder 344 and a signal 389 having a value corresponding to the sign of the value D; and produce an indication signal 387 having a value indicative of whether the expected partial remainder rRm+7.5D has the same sign as the value −D. For example, a zero value of signal 387 may indicate the expected partial remainder rRm+7.5D has the same sign as the value D, and a value one of signal 387 may indicate the expected partial remainder rRm+7.5D has a sign different than the sign of the value D. Detector 370 may additionally include other XOR gates, e.g., nine additional XOR gates (not shown), to analogously generate nine respective indication signals indicating a change of sign between rRm−4.5D and rRm−5.5D; between rRm−1.5D; and rRm−3.5D; between rRm−3.5D and rRm−2.5D; between rRm−2.5D and rRm−1.5D; between rRm+1.5D and rRm+2.5D; between rRm+2.5D and rRm+3.5D; between rRm+3.5D and rRm+4.5D; between rRm+4.5D and rRm+5.5D; and between rRm+5.5D rRm+6.5D.

According to some exemplary embodiments of the invention, one of the indication signals may have a value one, while other indication signals may have the value zero. Generating the quotient bit qₘ₊₁, based on a possible quotient digit corresponding to the indication signal having the value one, may result in a relatively reduced, e.g., minimal, partial remainder Rₘ₊₁. For example, if signal 379 has a value of one, then the sign of expected partial remainder rRm−5.5D, which corresponds to separator value C₋₆=5.5, may be different than the sign of expected partial remainder value rRm−6.5D, which corresponds to separator value C₋₇=−6.5. This may indicate that generating quotient digit qₘ₊₁=−6 may result in a reduced, e.g., minimal, partial remainder value Rₘ₊₁ compared to the partial remainder values resulting from the other possible quotient digits.

Some exemplary embodiments of the invention, e.g., as described herein, relate to generating one or more of the expected partial remainder values based on Equation 5, and using a sign generator, e.g., sign generator 330, and/or a detector, e.g., detector 370, adapted for detecting a change of sign between the expected partial remainder values. However, it will be appreciated by those skilled in the art that the expected partial remainder values may be determined using any other suitable equation and/or method. For example, one or more of the expected partial remainder values may be generated according to the equation Rⁱₘ₊₁=cᵢD−rRⁱₘ. The sign generator and/or the detector may be modified, according to the equation and/or method used for generating the expected partial remainder values. For example, signal 373 may have a value corresponding to the sign of the value D, and/or signal 389 may have a value corresponding to the sign of the value (−D), e.g., if one or more of the expected partial remainder values are generated according to the equation Rⁱₘ₊₁=cᵢD−rRⁱₘ.

Reference is made to FIG. 4, which schematically illustrates a quotient digit generator 400 according to some exemplary embodiments of the invention. Although the invention is not limited in this respect, generator 400 may perform the functionality of quotient digit generator 202 (FIG. 2).

Although the scope of the present invention is not limited in this respect, according to some exemplary embodiments of the invention, quotient digit generator 400 may be implemented as part of a quotient digit selector, e.g., selector 129, for generating a five-bit quotient digit qₘ₊₁, corresponding to one of seventeen possible quotient digits, e.g., corresponding to the values −8, −7, −6, −5, −4, −3, −2, −1, 0, 1, 2, 3, 4, 5, 6, 7 and 8. Accordingly generator 400 may be implemented, for example, as part of a quotient selector for performing a division operation of a radix of eight or more. However, it will be appreciated by those skilled in the art, that in other embodiments of the invention quotient digit generator 400 may be modified to enable generating any other quotient digit qₘ₊₁.

According to the exemplary embodiments of FIG. 4, generator 400 may include a plurality of OR gates, e.g., OR gates 402, 404, 406, 408, and 410. Gate 402 may generate a signal 412 having a value corresponding to a Least-Significant Bit (LSB) of quotient digit qₘ₊₁ based on a plurality of indication signals corresponding to the possible quotient digits having a LSB with a value one, e.g., quotient digits −7, −5, −3, −1, 1, 3, 5, and 7. For example, gate 402 may receive, e.g., from detector 370 (FIG. 3), the indication signals indicating a change of sign between rRm−7.5D and rRm−6.5D; between rRm−5.5D and rRm−4.5D; between rRm−3.5D and rRm−2.5D; between rRm−1.5D and rRm−0.5D; between rRm+0.5D and rRm+1.5D; between rRm+2.5D and rRm+3.5D; between rRm+4.5D and rRm+5.5D; and between rRm+6.5D and rRm+7.5D. Gate 404 may generate a signal 414 having a value corresponding to a second LSB of quotient digit qₘ₊₁ based on a plurality of indication signals corresponding to the possible quotient digits having a second LSB with a value of one, e.g., quotient digits −7, −6, −3, −2, 2, 3, 6 and 7. For example, gate 404 may receive, e.g., from detector 370 (FIG. 3), the indication signals indicating a change of sign between rRm−7.5D and rRm−6.5D; between rRm−6.5D and rRm−5.5D; between rRm−3.5D and rRm−2.5D; between rRm−2.5D and rRm−1.5D; between rRm+1.5D and rRm+2.5D; between rRm+2.5D and rRm+3.5D; between rRm+5.5D and rRm+6.5D; and between rRm+6.5D and rRm+7.5D. Gate 406 may generate a signal 416 having a value corresponding to a third LSB of quotient digit qₘ₊₁, based on a plurality of indication signals corresponding to the possible quotient digits having a third LSB with a value of one, e.g., quotient digits −7, −6, −5, −4, 4, 5, 6 and 7. For example, gate 406 may receive, e.g., from detector 370 (FIG. 3), the indication signals indicating a change of sign between rRm−7.5D and rRm−6.5D; between rRm−6.5D and rRm−5.5D; between rRm−5.5D and rRm−4.5D; between rRm−4.5D and rRm−3.5D; between rRm+3.5D and rRm+4.5D; between rRm+4.5D and rRm+5.5D; between rRm+5.5D and rRm+6.5D; and between rRm+6.5D and rRm+7.5D. Gate 408 may generate a signal 418 having a value corresponding to a second MSB of quotient digit qₘ₊₁ based on a plurality of indication signals corresponding to the possible quotient digits having a second MSB with a value of one, e.g., quotient digits −8, and 8. For example, gate 408 may receive, e.g., from detector 370 (FIG. 3), the indication signals 375 (FIG. 3) and 387 (FIG. 3). Gate 410 may generate a signal 420 having a value corresponding to a MSB of quotient digit qₘ₊₁, e.g., representing a sign of qₘ₊₁, based on a plurality of indication signals corresponding to the possible quotient digits having a sign with a value of one, e.g., quotient digits 1, 2, 3, 4, 5, 6, 7 and 8. For example, gate 410 may receive, e.g., from detector 370 (FIG. 3), indication signal 387 (FIG. 3) and the indication signals indicating a change of sign between rRm+7.5D and rRm+6.5D; between rRm+6.5D and rRm+5.5D; between rRm+5.5D and rRm+4.5D; between rRm+4.5D and rRm+3.5D; between rRm+3.5D and rRm+2.5D; between rRm+2.5D and rRm+1.5D; and between rRm+1.5D and rRm+0.5D.

According to some exemplary embodiments of the invention, one or more of the truncation number n and the boundary values l and h, may be predetermined based on one or more criterions. The one or more criterions may include, for example, a criterion corresponding to a convergence of the division operation, a desired efficiency level of the division operation, and/or a desired accuracy level of the division cycle, as described in detail below.

According to some exemplary embodiments of the invention, one or more of the expected partial remainder values may be determined using a truncated redundant form, e.g., including 17 bits after a fixed point of the redundant representation, as described above. Accordingly, the following equation may be used, for example, for representing the partial remainder corresponding to separator cᵢ:
cᵢD−rRₘ−Aᵢ+Eᵢ (7)
wherein Aᵢ denotes the truncated expected partial remainder corresponding to separator cᵢ, and Eᵢ denotes a truncation error. The truncated expected partial remainder may be represented, for example, as follows:
Ai=αₚαₚ₋₁ . . . α₀·α₋₁ . . . α₋ₙ (8)

The sign of the expected partial remainder corresponding to separator cᵢ may be determined, for example, as follows:
Sign (cᵢD−rRₘ)=αₚ (9)

Sign values sⱼ corresponding to expected partial remainder value R^{j}ₘ₊₁, wherein j=1 . . . h, may be determined, for example, based on the following conditions:
s₁=sign (−D)
sᵢ=sign(cᵢD−rRₘ) for i−l+1, . . . h−1 (10)
sₕ=sign(D)

According to some exemplary embodiments of the invention, a change between signs sᵢ and sᵢ₊₁, i.e., sᵢ≠sᵢ₊₁, may indicate that Aᵢ₊₁≧0 and Aᵢ<0, which in turn may be equivalent to:
Aᵢ≦2⁻ⁿ (11)

Substituting Equation 11 into Equation 7 may result in:
cᵢD−rRₘ≦Eᵢ−2⁻ⁿ
cᵢ₊₁D−rRₘ≧Eᵢ₊₁ (12)
which may be equivalent to:
cᵢD−Eᵢ+2⁻ⁿ≦rRₘ≦cᵢ₊₁D−Eᵢ₊₁ (13)

Equation 13 may be equivalent to the following equation, e.g., since c_{i<i≦c}ᵢ₊₁:
(cᵢ−i)D−Eᵢ2⁻ⁿ≦rRₘ−iD≦(cᵢ₊₁−i)D−Eᵢ₊₁ (14)

The partial remainder Rₘ₊₁, may be in the interval a≦Rₘ₊₁≦b, and the quotient digit qₘ₊₁ may be in the interval l≦qₘ₊₁<h, e.g., if the partial remainder Rₘ is in the interval a<Rₘ<b, wherein:

$$b = \frac{hD}{r - 1} \qquad ( 15 )$$

and wherein:

$$a = \frac{ID}{r - 1} \qquad ( 16 )$$

Substituting Equations 15 and 16 into Equation 14 may yield the following convergence criterion:

$$( {c}_{i} - i ) D - {E}_{i} + {2}^{- n} \geq \frac{lD}{r - 1} \\ ( {c}_{i + 1} - i ) D - {E}_{i + 1} \leq \frac{hD}{r - 1} \qquad ( 17 )$$

Substituting i+1 with i in Equation set 17 may yield the following convergence criterion:

$$( {c}_{i} - i ) D - {E}_{i} + {2}^{- n} \geq \frac{lD}{r - 1} \\ ( {c}_{i} - i + 1 ) D - {E}_{i} \leq \frac{hD}{r - 1} \qquad ( 18 )$$

Equation 18 may be rearranged as follows:

$$i + \frac{l}{r - 1} + \frac{{E}_{i} - {2}^{- n}}{D} \leq {c}_{i} \leq i + \frac{h}{r - 1} - 1 + \frac{{E}_{i}}{D} , l < i \leq h \qquad ( 19 )$$

According to some exemplary embodiments of the invention, one or more of truncation number n, and limit values l and/or h, may be determined based on the convergence criterion of Equation 19, e.g., as described below.

According to one exemplary embodiment of the invention, the limit values l=−8 and h=8 may be selected, e.g., if r=16. Thus, according to Equation 19, the plurality of separator values cᵢ may be selected within the following interval:

$$i - \frac{8}{15} + \frac{{E}_{i} - {2}^{- n}}{D} \leq {c}_{i} \leq i - \frac{7}{15} + \frac{{E}_{i}}{D} , - 8 < i \leq 8 \qquad ( 20 )$$

Selecting the truncation n=p+1=5, may result in the following separator values:

$${c}_{i} = i - \frac{1}{2} + \frac{1}{32 D} , - 8 < i \leq 8 \qquad ( 21 )$$

It is noted that the element 1/32D of Equation 21 may not depend on i. Accordingly, the separator values may be determined as follows:

$${c}_{i} = i - \frac{1}{2} , - 8 < i \leq 8 \qquad ( 22 )$$

Accordingly, the truncation error may be within the interval:

$$\frac{1}{32} - \frac{1}{15} \leq {E}_{i} \leq \frac{1}{32} + \frac{1}{30} \qquad ( 23 )$$

According to another exemplary embodiment of the invention, the limit values l=−8 and h=8 may be selected, e.g., if r=−8. Thus, according to Equation 19, the plurality of separator values cᵢ may be selected within the following interval:

$$i - \frac{8}{7} + \frac{{E}_{i} - {2}^{- n}}{D} \leq {c}_{i} \leq i + \frac{1}{7} + \frac{{E}_{i}}{D} , - 8 < i \leq 8 \qquad ( 24 )$$

Selecting the truncation n=0, i.e., truncation of the fractional part of the partial remainder, may enable using the following separator values:
cᵢ=i, −8<i≦8 (25)

Accordingly, the truncation error may be within the interval:

$$- \frac{1}{7} \leq {E}_{i} \leq 2 \frac{1}{7} \qquad ( 26 )$$

According to a further exemplary embodiment of the invention, the limit values l=−4 and h=4 may be selected, e.g., if r=4. Thus, according to Equation 19, the plurality of separator values cᵢ may be selected within the following interval:

$$i - \frac{4}{3} + \frac{{E}_{i} - {2}^{- n}}{D} \leq {c}_{i} \leq i + \frac{1}{3} + \frac{{E}_{i}}{D} , - 4 < i \leq 4 \qquad ( 27 )$$

Selecting the truncation n=0, i.e., truncation of the fractional part of the partial remainder, may enable using the separator values cᵢ=i.

Accordingly, the truncation error may be within the interval:

$$- \frac{1}{3} \leq {E}_{i} \leq 2 \frac{1}{3} \qquad ( 28 )$$

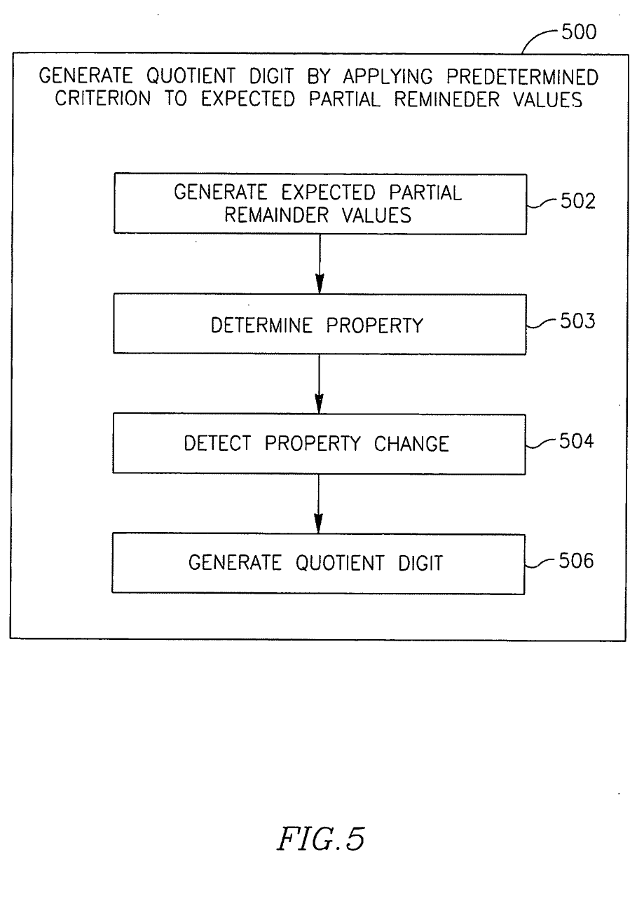

Reference is made to FIG. 5, which schematically illustrates a method of generating a quotient digit corresponding to a quotient of a division cycle, in accordance with some exemplary embodiments of the invention.

As indicated at block 500 the method may include generating quotient digit qₘ₊₁ corresponding to a quotient of cycle m+1 by applying a predetermined criterion to a plurality of expected partial remainder values related to a plurality of possible quotient digits. Generating quotient digit qₘ₊₁ may include, for example, using a quotient digit selector, e.g., selector 200 as described above with reference to FIG. 2.

As indicated at block 502, generating quotient digit qₘ₊₁ may include generating the plurality of expected partial remainder values. Generating the plurality of expected partial remainder values may include generating a plurality of expected partial remainder values corresponding to a plurality of separator values, which may be related to the plurality of possible quotient digits. Generating the plurality of expected partial remainder values may include, for example, using a partial remainder generator, e.g., generator 300 as described above with reference to FIG. 3.

As indicated at block 503, generating quotient digit qₘ₊₁ may include determining at least one property, e.g., a sign, of one or more of the expected partial remainder values. Determining the sign of one or more of the expected partial remainder values may include, for example, using a sign generator, e.g., generator 330 as described above with reference to FIG. 3.

As indicated at block 504, generating quotient digit qₘ₊₁ may include detecting a change in a mathematical property between one or more pairs of values of the plurality of expected partial remainder values. For example, the method may include detecting a change of sign between two expected partial remainder values. This may be achieved, for example, by comparing one or more pairs of consecutive sign values. Detecting the change of sign may include, for example, using detector, e.g., detector 370 as described above with reference to FIG. 3.

As indicated at block 506, generating quotient digit qₘ₊₁ may include generating quotient digit qₘ₊₁ based on the detected change in property. Generating the quotient digit based on the detected change in property may include, for example, using a quotient digit generator, e.g., generator 400 as described above with reference to FIG. 4.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. A method comprising:
generating a quotient digit corresponding to a quotient of a cycle of a division operation by applying a predetermined criterion to a plurality of expected partial remainder values related to a plurality of possible quotient digits.

2. The method of claim 1, wherein applying said criterion comprises detecting a change in a mathematical property between two values of said plurality of expected partial remainder values.

3. The method of claim 2, wherein detecting the change in said property comprises detecting a change of sign between two consecutive expected partial remainder values.

4. The method of claim 3, wherein detecting said change of sign comprises comparing the signs of one or more pairs of consecutive values in a plurality of sign values corresponding to said plurality of expected partial remainder values, respectively.

5. The method of claim 4 comprising generating said plurality of sign values based on said plurality of expected partial remainder values, respectively.

6. The method of claim 1, wherein said plurality of expected partial remainder values comprises a plurality of expected partial remainder values corresponding to a plurality of predetermined separator values, respectively.

7. The method of claim 6, wherein said plurality of separator values are shifted by a predetermined shift value in relation to said plurality of possible quotient digits.

8. The method of claim 1, wherein said plurality of expected partial remainder values comprises a plurality of truncated expected partial remainder values.

9. The method of claim 8, wherein at least one of said plurality of truncated expected partial remainder values corresponds to a predetermined number of most significant bits of a corresponding expected partial remainder value.

10. The method of claim 1, wherein generating said quotient digit comprises generating two or more bits representing said quotient digit.

11. The method of claim 10, wherein generating said two or more bits comprises generating four or more bits representing said quotient digit.

12. An apparatus comprising:
a quotient digit selector to generate a quotient digit corresponding to a quotient of a cycle of a division operation by applying a predetermined criterion to a plurality of expected partial remainder values related to a plurality of possible quotient digits.

13. The apparatus of claim 12, wherein said plurality of expected partial remainder values corresponds to a plurality of predetermined separator values, respectively.

14. The apparatus of claim 13, wherein said plurality of separator values are shifted by a predetermined shift value in relation to said plurality of possible quotient digits.

15. The apparatus of claim 12 comprising a partial remainder generator to generate said plurality of expected partial remainder values.

16. The apparatus of claim 15, wherein said partial remainder generator comprises a plurality of 3:2 carry-save-adders, and wherein at least one of said plurality of carry-save-adders generates a carry signal and a save signal corresponding to a respective one of said expected partial remainder values.

17. The apparatus of claim 12 comprising a sign generator to generate a plurality of sign signals corresponding to the signs of said plurality of expected partial remainder values, respectively.

18. The apparatus of claim 17, wherein said sign generator comprises a plurality of adders to generate said plurality of sign signals based on a plurality of carry and save signals representing said plurality of expected partial remainder values, respectively.

19. The apparatus of claim 12 comprising a detector to detect a change of value between a plurality of signals representing a mathematical property of said plurality of expected partial remainder values.

20. The apparatus of claim 19, wherein said mathematical property comprises a sign of said expected partial remainder values, said detector comprising a plurality of exclusive-OR gates to generate a plurality of indication signals indicative of a change of value between said signals.

21. The apparatus of claim 12 comprising a quotient-digit generator to generate said quotient digit.

22. The apparatus of claim 12, wherein said quotient digit selector is able to generate two or more bits representing said quotient digit.

23. The apparatus of claim 22, wherein said quotient digit selector is able to generate four or more bits representing said quotient digit.

24. A computing platform comprising:
a processor including a quotient digit selector to generate a quotient digit corresponding to a quotient of a cycle of a division operation by applying a predetermined criterion to a plurality of expected partial remainder values related to a plurality of possible quotient digits; and
a memory associated with said processor and able to store one or more values corresponding to said division operation.

25. The computing platform of claim 24, wherein said plurality of expected partial remainder values corresponds to a plurality of predetermined separator values, respectively.

26. The computing platform of claim 24, wherein said quotient digit selector comprises a sign generator to generate a plurality of sign signals corresponding to said plurality of expected partial remainder values, respectively.

27. The computing platform of claim 24, wherein said quotient digit selector comprises a detector to detect a change of value between a plurality of signals representing a mathematical property of said plurality of expected partial remainder values.

28. The computing platform of claim 24, wherein said quotient digit selector is able to generate four or more bits representing said quotient digit.
